(19) United States
(12) Patent Application Publication
(10) Pub. No.: US 2010/0309157 A1
(43) Pub. Date: Dec. 9, 2010

(54) LIGHT SOURCE FOR A TOUCH SCREEN

(75) Inventors: Xinlin Ye, Beijing (CN); Jianjun Liu, Beijing (CN); Xinbin Liu, Beijing (CN); Zhenzhong Zou, Beijing (CN)

Correspondence Address: BANNER & WITCOFF, LTD., 1100 13th STREET, N.W., SUITE 1200, WASHINGTON, DC, 20005-4051, US

(73) Assignee: Beijing Irtouch Systems Co., Ltd., Beijing (CN)

(21) Appl. No.: 12/793,176

(22) Filed: Jun. 3, 2010

(30) Foreign Application Priority Data
Jun. 5, 2009 (CN) 200920108448.X

(51) Int. Cl. G06F 3/041; F21V 7/04

(52) U.S. Cl. 345/173; 362/611

(57) ABSTRACT

The present invention discloses a light source for a touch screen. The light source is disposed on the frame of the touch screen, and comprises at least one light-emitting body and at least one light-transmission body, wherein the at least one light-transmission body has light scattering medium evenly distributed therein. This kind of light source is a new type of low cost light source for a touch screen, thus reducing production cost of the touch screen and expanding its application field.

### TECHNICAL FIELD OF THE INVENTION

The present invention relates to a light source, in particular, to a light source for a touch screen.

### BACKGROUND OF THE INVENTION

With the development of touch screen technology, touch screens are widely used in various fields, and can be seen everywhere from past industrial control, medical instruments, to today's large amount of consumer electronic products. In the meantime, it has made a fundamental breakthrough in the manner of touching, which has been changed from single-touch to multi-touch, making the usage of touch screen more humanized.

Light source is an important component for certain touch screens, especially for camera based touch screen. It plays an indispensable role in the process of realizing positioning with camera. Currently, most light sources employ a plurality of point light sources disposed in adjacent to an image sensor device to illuminate the entire detection region. Due to the power and lifetime of the light source itself, the size of the detection region and the service time of the entire device are subject to certain limitation, and with the increase in the number of light sources, energy consumption will also increase. In addition, some existing touch technologies perform illumination with optical fibers etc., the cost of which is relatively high. The light source used in other touch technologies also has certain deficiencies.

### SUMMARY

The present invention provides an economical and practical light source for a touch screen to overcome the defects in the prior art.

According to one aspect of the invention, there is provided a light source for a touch screen, the light source being disposed on the frame of the touch screen, and comprising at least one light-emitting body and at least one light-transmission body, the at least one light-transmission body having light scattering medium evenly distributed therein.

Further, the light scattering medium is a combination of one or more of tiny air bubble, organic glass (PMMA), acrylic, microcrystalline glass and polycrystalline ceramic that have different refractive indexes from that of the light-transmission body.

Still further, the at least one light-transmission body is one of cylindrical shape, elliptoid cylindrical shape or multi-sided prismatic shape.

Still further, the number of the at least one light-transmission body can be one, and the at least one light-transmission body is disposed on an arbitrary edge of the frame of the touch screen.

Still further, the number of the at least one light-transmission body can be more than one, and the at least one light-transmission body is disposed on one or more edges of the frame of the touch screen.

Still further, each two of the at least one light-transmission body has a light-emitting body disposed therebetween.

Further, the at least one light-emitting body is disposed on side of or inside of the at least one light-transmission body.

Further, the at least one light-emitting body is disposed at one or both ends of the light-transmission body.

Still further, the at least one light-emitting body is an infrared light-emitting body.

The light source for a touch screen according to the present invention employs light-emitting bodies and light-transmission bodies that have relatively low cost as illumination component for the touch screen, which reduces manufacturing cost of the touch screen and improves market competitive power thereof.

### BRIEF DESCRIPTION OF THE DRAWINGS

FIG. 1 is a diagram illustrating a manner of applying the light source on a touch screen according to the first embodiment of the present invention;

FIG. 2 is a structure diagram of the first type of light-emitting body and light-transmission body according to the first embodiment of the present invention;

FIG. 3 is a diagram illustrating another manner of applying the light source on a touch screen according to the first embodiment of the present invention;

FIG. 4 is a structure diagram of the second type of light-emitting body and light-transmission body according to the second embodiment of the present invention;

FIG. 5 is a structure diagram of the third type of light-emitting body and light-transmission body according to the third embodiment of the present invention.

### DETAILED DESCRIPTION OF THE PREFERRED EMBODIMENTS

It is believed that the above and other objectives, features and advantages of the present invention will become clearer through the following detailed description of the embodiments of the present invention in conjunction with the drawings.

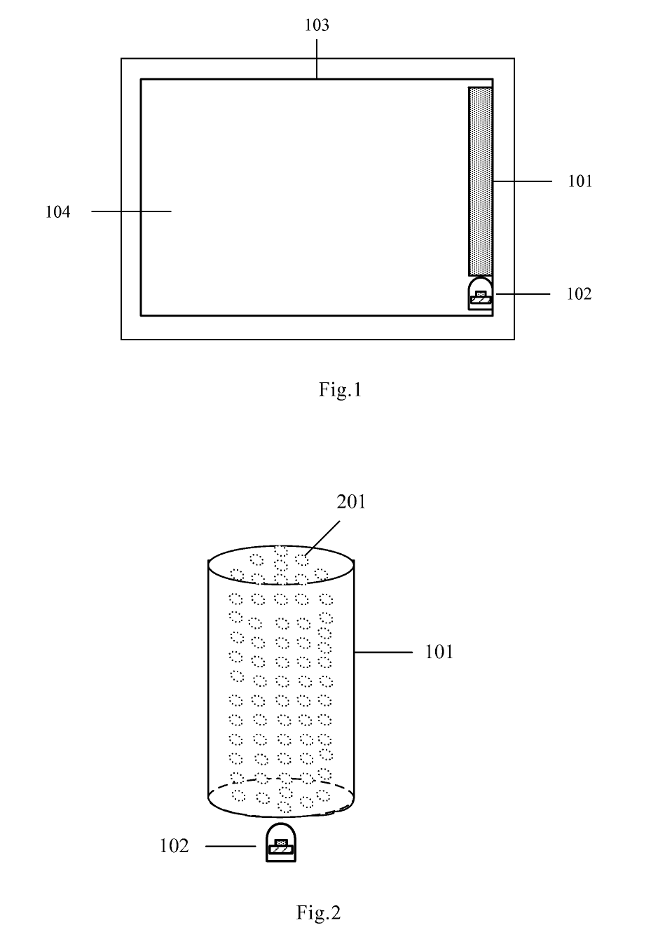

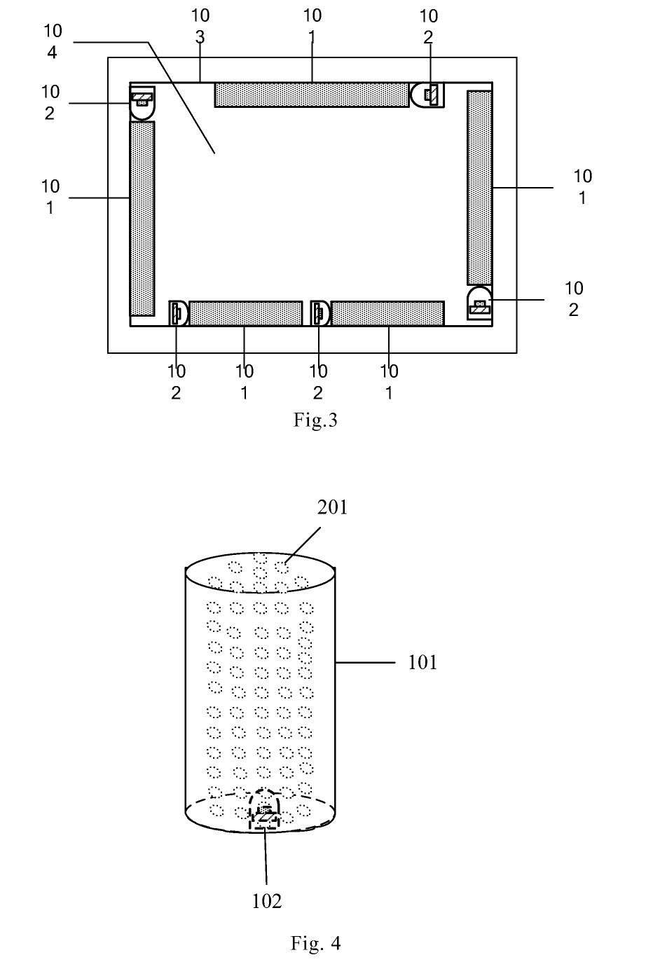

Embodiment (1): as illustrated in FIGS. 1 and 2, the light source for a touch screen according to an embodiment of the present invention mainly comprises a light-transmission body 101 and a light-emitting body 102, wherein the light-transmission body has light scattering medium 201 evenly distributed therein. The light-emitting body 102 is located at one end of the light-transmission body 101 which can be made of material such as organic glass (PMMA), microcrystalline glass or polycrystalline ceramic with high light transmittance. The light scattering medium 201 is tiny air bubbles evenly distributed within the light-transmission body 101 or can be a combination of one or more of organic glass, acrylic, microcrystalline glass and polycrystalline ceramic that have different refractive indexes from that of the light-transmission body. The light scattering medium 201 in the present embodiment is tiny air bubbles. The light-transmission body 101 may be one of cylindrical shape, elliptoid cylindrical shape or multi-sided prismatic shape. In the present embodiment, it is a cylindrical light-transmission body as illustrated in FIG. 2, within which many tiny air bubbles are evenly distributed to be used as the light scattering medium 201. At the lower end of this cylindrical light-transmission body, there is a light-emitting body 102 which is an infrared light-emitting body radiating infrared light into the lower end surface of this cylindrical light-transmission body. The infrared light propagates through this cylindrical light-transmission body 101, gets scattering by the light scattering medium 201 and forms the light source of the touch screen together with the light-emitting body 102. The number of the light-transmission body can be more than one. In case that the number is one, the light-transmission body 101 can be disposed on an arbitrary edge of the frame 103 of the touch screen; in case that the number is more than one, the light-transmission bodies 101 can be disposed on one or more edges of the frame 103 of the touch screen. In the present embodiment, as illustrated in FIG. 1, there is one light-transmission body 101 and one light-emitting body 102 which is located at one end of this light-transmission body. They are disposed together on one edge of the frame 103 of the touch screen, capable of illuminating the whole touch region 104 through the principle of light scattering. In addition, the number of the light source can be determined based on the size of a specific touch screen. For a touch screen with a relatively large size, there may be disposed one such light source on each frame 103, or even several such light sources on a same frame 103, so as to achieve excellent illumination effect. In the present embodiment, as illustrated in FIG. 3, there are used totally five such light sources, wherein three light sources are disposed on three consecutive edges of the frame 103 respectively, and two such light sources are disposed on the other edge at the same time. Each light source comprises a light-transmission body 101 and a light-emitting body 102, wherein the light-transmission body 101 is a cylindrical light-transmission body made of organic glass, within which many tiny air bubbles are evenly distributed to be used as the light scattering medium 201, and the light-emitting body 102 is an infrared light-emitting body. Finally, depending on actual need, there may be disposed one light-emitting body 102 between each two light-transmission bodies 101, or disposed two light-emitting bodies 102 at both ends of a light-transmission body 101 to achieve better effect.

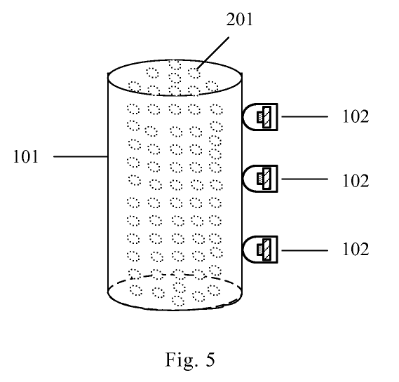

Embodiment (2): as illustrated in FIG. 4, it differs from embodiment (1) in that, the light-emitting body 102 in the light source is disposed inside and at bottom of the light-transmission body 101, which saves the installation space.

Embodiment (3): as illustrated in FIG. 5, it differs from embodiment (1) and embodiment (2) in that, the light-emitting bodies 102 of the light source are disposed near a side surface of the light-transmission body 101, to achieve the same illumination effect.

It can be understood that the light sources according to various embodiments are used for camera based touch screen. Further, the touch screen can be used for an interactive display device.

The method according to the present invention is not limited to the embodiments described in detail. For example, depending on different installation environment, the light-transmission body in the light source may adopt different shapes such as cylinder, elliptoid cylinder or various multi-sided prisms which can achieve equal implementation effect. Other implementations derived by those skilled in the art from the technical solution of the invention are also within the scope of technical innovation of the present invention.

1. A light source for a touch screen, the light source being disposed on the frame of the touch screen, characterized in that: said light source comprises at least one light-emitting body and at least one light-transmission body, said at least one light-transmission body having light scattering medium evenly distributed therein.

2. The light source for a touch screen according to claim 1, wherein said light scattering medium is a combination of one or more of tiny air bubbles, organic glass, acrylic, microcrystalline glass and polycrystalline ceramic that have different refractive indexes from that of said light-transmission body.

3. The light source for a touch screen according to claim 2, wherein said at least one light-transmission body is one of cylindrical shape, elliptoid cylindrical shape or multi-sided prismatic shape.

4. The light source for a touch screen according to claim 3, wherein the number of said at least one light-transmission body is one, and said at least one light-transmission body is disposed on an arbitrary edge of the frame of said touch screen.

5. The light source for a touch screen according to claim 3, wherein the number of said at least one light-transmission body is more than one, and said at least one light-transmission body is disposed on one or more edges of the frame of said touch screen.

6. The light source for a touch screen according to claim 5, wherein each two of said at least one light-transmission body has a light-emitting body disposed therebetween.

7. The light source for a touch screen according to any one of claims 1 to 6, wherein said at least one light-emitting body is disposed on side of or inside of said at least one light-transmission body.

8. The light source for a touch screen according to any one of claims 1 to 6, wherein said at least one light-emitting body is disposed at one or both ends of the light-transmission body.

9. The light source for a touch screen according to claim 7, wherein said at least one light-emitting body is an infrared light-emitting body.

10. The light source for a touch screen according to claim 8, wherein said at least one light-emitting body comprises an infrared light-emitting body.

11. A touch screen, comprising the light source according to any one of claims 1 to 5.
